(19) United States
(12) Patent Application Publication
(10) Pub. No.: US 2013/0183548 A1
(43) Pub. Date: Jul. 18, 2013

(54) COMPOSITIONS, LAYERINGS, ELECTRODES AND METHODS FOR MAKING

(71) Applicant: E I DU PONT DE NEMOURS AND COMPANY, Wilimington, DE (US)

(72) Inventors: Kostantinos Kourtakis, Media, PA (US); Brent Wise, Wilimington, DE (US)

(73) Assignee: E I DU PONT DE NEMOURS AND COMPANY, Wilmington, DE (US)

(21) Appl. No.: 13/743,793

(22) Filed: Jan. 17, 2013

Related U.S. Application Data
(60) Provisional application No. 61/587,817, filed on Jan. 18, 2012.

(51) Int. Cl. H01M 4/36

(52) U.S. Cl. CPC H01M 4/366
USPC 429/50; 429/217; 429/231.8; 252/182.1; 427/58

(57) ABSTRACT

There is a carbon-sulfur composite; and there is a composition comprising about 1 to 17.5 wt. % polymeric binder and about 50 to 99 wt. % carbon-sulfur composite comprising carbon powder having a surface area of about 50 to 4,000 square meters per gram and a pore volume of about 0.5 to 6 cubic centimeters per gram. The carbon powder comprises carbon having a macromolecular structure ordered in at least two dimensions and characterized by having two-dimensional carbon sheets which are stacked into carbon layers. The carbon-sulfur composite also comprises about 5 to 95 wt. % sulfur compound. There is also a layering comprising a plurality of coatings. Respective coatings in the plurality of coatings can comprise respective compositions. The respective coatings can comprise at least one polymeric binder and at least one carbon-sulfur composite comprising carbon powder and sulfur compound. There are also electrodes comprising a composition or a layering and methods of using such in cells.

### CROSS-REFERENCE TO RELATED APPLICATIONS

This application claims priority on and the benefit of the filing date of U.S. Provisional Application Nos. 61/587,817, filed on Jan. 18, 2012, and U.S. Provisional Application Nos. 61/597,915, filed on Feb. 13, 2012, the entirety of which is herein incorporated by reference.

### BACKGROUND OF THE INVENTION

There is significant interest in lithium sulfur (i.e., “Li—S”) batteries as potential portable power sources for their applicability in different areas. These areas include emerging areas, such as electrically powered automobiles and portable electronic devices, and traditional areas, such as car ignition batteries. Li—S batteries offer great promise in terms of cost, safety and capacity, especially compared with lithium ion battery technologies not based on sulfur. For example, elemental sulfur is often used as a source of electroactive sulfur in a Li—S cell of a Li—S battery. The theoretical charge capacity associated with electroactive sulfur in a Li—S cell based on elemental sulfur is about 1,672 mAh/g S. In comparison, a theoretical charge capacity in a lithium ion battery based on a metal oxide is often less than 250 mAh/g metal oxide. For example, the theoretical charge capacity in a lithium ion battery based on the metal oxide species LiFePO₄ is 176 mAh/g.

A Li—S battery includes one or more electrochemical voltaic Li—S cells which derive electrical energy from chemical reactions occurring in the cells. A cell includes at least one positive electrode. When a new positive electrode is initially incorporated into a Li—S cell, the electrode includes an amount of sulfur compound incorporated within its structure. The sulfur compound includes potentially electroactive sulfur which can be utilized in operating the cell. A negative electrode in a Li—S cell commonly includes lithium metal. In general, the cell includes a cell solution with one or more solvents and electrolytes. The cell also includes one or more porous separators for separating and electrically isolating the positive electrode from the negative electrode, but permitting diffusion to occur between them in the cell solution. Generally, the positive electrode is coupled to at least one negative electrode in the same cell. The coupling is commonly through a conductive metallic circuit.

Li—S cell configurations also include, but are not limited to, those having a negative electrode which initially does not include lithium metal, but includes another material. Examples of these materials are graphite, silicon-alloy and other metal alloys. Other Li—S cell configurations include those with a positive electrode incorporating a lithiated sulfur compound, such as lithium sulfide (Li₂S).

The sulfur chemistry in a Li—S cell involves a related series of sulfur compounds. During a discharge phase in a Li—S cell, lithium is oxidized to form lithium ions. At the same time larger or longer chain sulfur compounds in the cell, such as S₈ and Li₂S₈, are electrochemically reduced and converted to smaller or shorter chain sulfur compounds. In general, the reactions occurring during discharge may be represented by the following theoretical discharging sequence of the electrochemical reduction of elemental sulfur to form lithium polysulfides and lithium sulfide:

S₈→Li₂S₈→Li₂S₆→Li₂S₄→Li₂S₃→Li₂S₂→Li₂S

During a charge phase in a Li—S cell, a reverse process occurs. The lithium ions are drawn out of the cell solution. These ions may be plated out of the solution and back to a metallic lithium negative electrode. The reactions may be represented, generally, by the following theoretical charging sequence representing the electrooxidation of the various sulfides to elemental sulfur:

Li₂S→Li₂S₂→Li₂S₃→Li₂S₄→Li₂S₆→Li₂S₈→S₈

A common limitation of previously-developed Li—S cells and batteries is capacity degradation or capacity “fade”. It is generally believed that capacity fade is due, in part, to sulfur loss through the formation of certain soluble sulfur compounds which “shuttle” between electrodes in a Li—S cell and react to deposit on a surface of a negative electrode forming “anode-deposited” sulfur compounds. It is believed that the anode-deposited sulfur compounds can obstruct and otherwise foul the surface of the negative electrode and may also result in sulfur loss from the total electroactive sulfur in the cell. The formation of anode-deposited sulfur compounds involves complex chemistry which is not completely understood.

Some previously-developed Li—S cells and batteries have utilized high loadings of sulfur compound in their positive electrodes in attempting to address the drawbacks associated with capacity degradation and anode-deposited sulfur compounds. However, simply utilizing a high loading of sulfur compound presents other difficulties, including a lack of adequate containment for the entire amount of sulfur compound in the high loading. Furthermore, the positive electrodes made with these compositions tend to crack or break. Another difficulty might be due, in part, to the insulating effect of the high loading of sulfur compound. This insulating effect may contribute to difficulties in realizing the full capacity associated with all the potentially electroactive sulfur in the high loading in a positive electrode of these previously-developed Li—S cell and batteries.

Conventionally, the lack of adequate containment for a high loading of sulfur compound has been addressed by incorporating a high amount of binder in the positive electrodes of these previously-developed Li—S cell and batteries. However, a positive electrode incorporating a high binder amount tends to have a lower sulfur utilization which, in turn, lowers the effective maximum discharge capacity of the Li—S cells with these electrodes.

Li—S cells and batteries are desirable based on the high theoretical capacities and high theoretical energy densities of the electroactive sulfur in their positive electrodes. However, attaining the full theoretical capacities and energy densities remains elusive. In addition, the concomitant limitations associated with capacity degradation, anode-deposited sulfur compounds and the poor conductivities intrinsic to sulfur compound itself, all of which are associated with previously-developed Li—S cells and batteries, limits the application and commercial acceptance of Li—S batteries as power sources.

Given the foregoing, what are needed are Li—S cells and batteries without the above-identified limitations of previously-developed Li—S cells and batteries.

### BRIEF SUMMARY OF THE INVENTION

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing components, such as compositions comprising carbon-sulfur (i.e., C—S) composite, and structures, such as layerings, relating to positive electrodes for Li—S cells and batteries. In addition, the positive electrodes incorporating the components and/or structures are also provided as well as associated methods of making and methods of using.

The positive electrodes provide Li—S cells and batteries with surprisingly high maximum discharge capacities and without the above-identified limitations of previously-developed Li—S cells and batteries. While not being bound by any particular theory, it is believed that the compositions comprising the C—S composite and the layering structure, when incorporated in the positive electrodes, provide high maximum discharge capacity Li—S cells with a positive electrode which does not tend to crack or break. Furthermore, low sulfur utilization and high discharge capacity degradation are avoided in these cells.

These and other objects are accomplished by the compositions comprising C—S composite, the layerings, the positive electrodes, methods for making such and methods for using such, in accordance with the principles of the invention.

According to a first principle of the invention, there is provided a C—S composite, as described below. This C—S composite may be used itself for a variety of purposes, one of which is as a component of a composition as described herein. As a result, there is, according to an additional principle of the invention, a composition, one of the components of which can be a C—S composite as provided herein. The composition may comprise about 1 to 17.5 wt. % polymeric binder and about 50 to 99 wt. % C—S composite. The C—S composite may comprise carbon powder characterized by having a surface area of about 50 to 4,000 square meters per gram and a pore volume of about 0.5 to 6 cubic centimeters per gram. The carbon powder may comprise carbon having a macromolecular structure ordered in at least two dimensions. The macromolecular structure may be characterized by having two-dimensional carbon sheets which may be stacked into carbon layers. The C—S composite may also comprise about 5 to 95 wt. % sulfur compound in the C—S composite. The macromolecular structure may be ordered in two dimensions. The macromolecular structure may be ordered in three dimensions. The carbon layers may be associated with a stacking sequence of the two dimensional carbon sheets. The carbon sheets may be associated with basal planes that have slipped out of alignment relative to each other in the macromolecular structure. The carbon layers in the macromolecular structure may have sufficient freedom to randomly translate relative to each other and rotate about a normal of the carbon layers. The carbon powder may be characterized by having a surface area above about 900 square meters per gram carbon powder. The carbon powder may be characterized by having a surface area above about 1,400 square meters per gram carbon powder. The composition may comprise about 1 to 9 wt. % polymeric binder. The composition may comprise about 1 to 6 wt. % polymeric binder. The carbon powder may be characterized by having a surface area of about 900 to 1,900 square meters per gram or a pore volume of about 1.2 to 5 cubic centimeters per gram. The C—S composite may be made using a compositing process comprising at least one compositing step. A compositing step in the at least one compositing step may comprise heating the sulfur compound or introducing the heated sulfur compound into the carbon powder to make the C—S composite. The compositing process may include heating the sulfur compound to about 160° C. or directly contacting the heated sulfur compound with the carbon powder. The compositing process may include heating the sulfur compound to about 300° C. to form a sulfur vapor and contacting the sulfur vapor with the carbon powder.

According to a second principle of the invention, there is a method for making a composition. The method comprises combining about 1 to 17.5 wt. % polymeric binder and about 50 to 99 wt. % C—S composite. The C—S composite may carbon powder characterized by having a surface area of about 50 to 4,000 square meters per gram and a pore volume of about 0.5 to 6 cubic centimeters per gram. The carbon powder may comprise carbon having a macromolecular structure ordered in at least two dimensions. The macromolecular structure may be characterized by having two-dimensional carbon sheets which may be stacked into carbon layers. The C—S composite may also comprise about 5 to 95 wt. % sulfur compound in the C—S composite. The macromolecular structure may be ordered in two dimensions. The macromolecular structure may be ordered in three dimensions. The carbon layers may be associated with a stacking sequence of the two dimensional carbon sheets. The C—S composite may also comprise about 5 to 95 wt. % sulfur compound in the C—S composite.

According to a third principle of the invention, there is a layering. The layering comprises a plurality of coatings with respective coatings in the plurality of coatings. The respective coatings may comprise respective compositions based on at least one composition. The respective compositions may comprise at least one polymeric binder. The respective compositions may comprise at least one C—S composite, comprising at least one carbon powder, and at least one sulfur compound. The respective compositions may comprise at least one component other than the at least one polymeric binder and the at least one carbon-sulfur composite. The respective compositions may comprise about 1 to 17.5 average wt. % polymeric binder. The respective compositions may comprise about 50 to 99 average wt. % C—S composite. The at least one C—S composite may comprise at least one carbon powder characterized by having a surface area of about 50 to 4,000 square meters per gram or a pore volume of about 0.5 to 6 cubic centimeters per gram. The at least one C—S composite may comprise at least one carbon powder comprising carbon. The carbon may have a macromolecular structure ordered in at least two dimensions or characterized by having two-dimensional carbon sheets which may be stacked into carbon layers. The at least one C—S composite may comprise about 5 to 95 average wt. % of at least one sulfur compound. The respective compositions may comprise at least one of respective polymeric binders, respective C—S composites, formed from respective carbon powders loaded with respective sulfur compounds, and the at least one component. The respective compositions may be the same or different based on at least one of an amount or a quality of at least one of the respective polymeric binders, the respective C—S composites, the respective carbon powders or the respective sulfur compounds. The plurality of coatings may comprise at least one coating comprising a respective composition comprising about 0 to 100 wt. % polymeric binder, about 0 to 100 wt. % C—S composite, or about 0 to 100 wt. % conductive carbon black, and the sum of the weight percentages of polymeric binder, C—S composite and conductive carbon black in the at least one coating may be 100 wt. % or less. The respective compositions may comprise about 1 to 9 average wt. % of at least one polymeric binder. The layering may be made using a layering process comprising a plurality of coating steps. A coating step in the plurality may comprise applying a respective composition of the respective compositions combined with a solvent to a surface. The layering process may comprise at least one drying step. A drying step in the at least one drying step may comprise evaporating at least a part of the solvent.

According to a fourth principle of the invention, there is a method for making a layering. The method comprises combining at least one solvent with at least one composition to make at least one mixture for a plurality of coatings. The respective coatings in the plurality of coatings may comprise respective compositions based on the least one composition. The respective compositions comprise at least one of at least one polymeric binder, at least one C—S composite and at least one component other than the at least one polymeric binder and the at least one carbon-sulfur composite. The at least one C—S composite comprises at least one carbon powder, and at least one sulfur compound. The method also includes applying the at least one mixture to make a plurality of coatings forming a layering. The layering may be made using a layering process comprising a plurality of coating steps, a coating step in the plurality comprising applying a respective mixture of the at least one mixture to a surface. The layering process may comprise at least one drying step, a drying step in the at least one drying step comprising evaporating at least a part of the solvent of the at least one mixture applied to the surface. The applying may be characterized as being at least one of spray coating, dip coating, spin coating and air brushing. A plurality of the coating steps in the plurality of coating steps may apply respective mixtures of the at least one mixture and the applied respective mixtures may differ from each other based on at least one of an amount and a quality of at least one component in the respective mixtures. The respective compositions may comprise at least one of respective polymeric binders and respective C—S composites formed from respective carbon powders loaded with respective sulfur compounds. The respective compositions may be the same or different based on at least one of an amount and a quality of at least one of the respective polymeric binders, the respective C—S composites, the respective carbon powders, the respective sulfur compounds or the at least one component. The plurality of coatings may comprise at least one coating comprising a respective composition comprising about 0 to 100 wt. % polymeric binder, about 0 to 100 wt. % C—S composite, or about 0 to 100 wt. % conductive carbon black. A sum of the weight percentages of polymeric binder, C—S composite and conductive carbon black in the at least one coating may be 100 wt. % or less. The components of the respective compositions may comprise about 1 to 9 average wt. % of at least one polymeric binder. The components of the respective compositions may comprise about 1 to 6 average wt. % polymeric binders. The components of the respective compositions may comprise about 1 to 3 average wt. % polymeric binders.

According to a fifth principle of the invention, there is an electrode comprising a circuit contact and a composition. The composition may comprise

about 1 to 17.5 average wt. % of at least one polymeric binder and

about 50 to 99 average wt. % of at least one C—S composite. The C—S composite may comprise carbon powder characterized by having a surface area of about 50 to 4,000 square meters per gram and a pore volume of about 0.5 to 6 cubic centimeters per gram. The carbon powder may comprise carbon having a macromolecular structure ordered in at least two dimensions. The macromolecular structure may be characterized by having two-dimensional carbon sheets which may be stacked into carbon layers. The C—S composite may also comprise about 5 to 95 wt. % sulfur compound in the C—S composite. The macromolecular structure may be ordered in two dimensions. The macromolecular structure may be ordered in three dimensions. The carbon layers may be associated with a stacking sequence of the two dimensional carbon sheets. The carbon sheets may be associated with basal planes that have slipped out of alignment relative to each other in the macromolecular structure. The carbon layers in the macromolecular structure may have sufficient freedom to randomly translate relative to each other and rotate about a normal of the carbon layers. The carbon powder may be characterized by having a surface area above about 900 square meters per gram carbon powder. The carbon powder may be characterized by having a surface area above about 1,400 square meters per gram carbon powder. The composition may comprise about 1 to 9 wt. % polymeric binder. The composition may comprise about 1 to 6 wt. % polymeric binder. The carbon powder may be characterized by having a surface area of about 900 to 1,900 square meters per gram or a pore volume of about 1.2 to 5 cubic centimeters per gram.

According to a sixth principle of the invention, there is an electrode comprising a circuit contact and a layering. The layering comprises a plurality of coatings with respective coatings in the plurality of coatings. The respective coatings comprise respective compositions based on at least one composition. The respective compositions may comprise at least one polymeric binder. The respective compositions may comprise at least one component other than the at least one polymeric binder and the at least one carbon-sulfur composite. The respective compositions may comprise at least one C—S composite, comprising at least one carbon powder, and at least one sulfur compound. The respective compositions may comprise about 1 to 17.5 average wt. % polymeric binder. The respective compositions may comprise about 50 to 99 average wt. % C—S composite. The at least one C—S composite may comprise at least one carbon powder characterized by having a surface area of about 50 to 4,000 square meters per gram or a pore volume of about 0.5 to 6 cubic centimeters per gram. The at least one C—S composite may comprise at least one carbon powder comprising carbon. The carbon may have a macromolecular structure ordered in at least two dimensions or characterized by having two-dimensional carbon sheets which may be stacked into carbon layers. The at least one C—S composite may comprise about 5 to 95 average wt. % of at least one sulfur compound. The respective compositions may comprise at least one of respective polymeric binders and respective C—S composites formed from respective carbon powders loaded with respective sulfur compounds. The respective compositions may be the same or different based on at least one of an amount or a quality of at least one of the respective polymeric binders, the respective C—S composites, the respective carbon powders, the respective sulfur compounds or the at least one component. The plurality of coatings may comprise at least one coating comprising a respective composition comprising about 0 to 100 wt. % polymeric binder, about 0 to 100 wt. % C—S composite, or about 0 to 100 wt. % conductive carbon black, and the sum of the weight percentages of polymeric binder, C—S composite and conductive carbon black in the at least one coating may be 100 wt. % or less. The respective compositions may comprise about 1 to 9 average wt. % of at least one polymeric binder. The layering may be made using a layering process comprising a plurality of coating steps. A coating step in the plurality may comprise applying a respective composition of the respective compositions combined with a solvent to a surface. The layering process may comprises at least one drying step. A drying step in the at least one drying step may comprise evaporating at least a part of the solvent.

According to a seventh principle of the invention, there is a method for using a cell, comprising at least one step from the plurality of steps comprising converting chemical energy stored in the cell into electrical energy, and converting electrical energy into chemical energy stored in the cell. The cell comprises a negative electrode, a circuit coupling the positive electrode with the negative electrode, an electrolyte medium, and a positive electrode. The positive electrode may comprise (a) a layering comprising a plurality of coatings with respective coatings in the plurality of coatings. The respective coatings comprise respective compositions based on at least one composition. The respective compositions may comprise at least one polymeric binder. The respective compositions may comprise at least one C—S composite, comprising at least one carbon powder, and at least one sulfur compound. The respective compositions may comprise at least one component other than the at least one polymeric binder and the at least one carbon-sulfur composite. The respective compositions may comprise about 1 to 17.5 average wt. % polymeric binder. The respective compositions may comprise about 50 to 99 average wt. % C—S composite. The at least one C—S composite may comprise at least one carbon powder characterized by having a surface area of about 50 to 4,000 square meters per gram or a pore volume of about 0.5 to 6 cubic centimeters per gram. The at least one C—S composite may comprise at least one carbon powder comprising carbon. The carbon may have a macromolecular structure ordered in at least two dimensions or characterized by having two-dimensional carbon sheets which may be stacked into carbon layers. The at least one C—S composite may comprise about 5 to 95 average wt. % of at least one sulfur compound. The positive electrode may comprise (b) a composition. The composition may comprise about 1 to 17.5 average wt. % of at least one polymeric binder and about 50 to 99 average wt. % of at least one C—S composite. The C—S composite may comprise carbon powder characterized by having a surface area of about 50 to 4,000 square meters per gram and a pore volume of about 0.5 to 6 cubic centimeters per gram. The carbon powder may comprise carbon having a macromolecular structure ordered in at least two dimensions. The macromolecular structure may be characterized by having two-dimensional carbon sheets which may be stacked into carbon layers. The C—S composite may also comprise about 5 to 95 wt. % sulfur compound in the C—S composite. The cell may be associated with at least one of a portable battery, a power source for an electrified vehicle, a power source for an ignition system of a vehicle and a power source for a mobile device.

The above summary is not intended to describe each embodiment or every implementation of the present invention. Further features, their nature and various advantages will be more apparent from the accompanying drawings and the following detailed description of the examples and embodiments.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the drawings in the figures, which highlight the aspects, methodology, functionality and advantages of the present invention, are presented for example purposes only. The present invention is sufficiently flexible, such that it may be implemented in ways other than that shown in the accompanying figures.

FIG. 1 is a schematic depicting a two-dimensional perspective of a Li—S cell incorporating a positive electrode, according to an example;

FIG. 2 is a context diagram depicting properties of a Li—S battery comprising a Li—S cell incorporating a positive electrode, according to an example;

FIG. 3 is a schematic depicting a two-dimensional perspective of a Li—S coin cell incorporating a positive electrode, according to an example;

FIG. 4 is a graph depicting measurements of the maximum discharge capacity measured for a series of cycles for two positive electrodes, according to different examples; and

FIG. 5 is a graph depicting measurements of the maximum discharge capacity measured for a series of charge-discharge cycles for two positive electrodes, according to different examples.

### DETAILED DESCRIPTION

The present invention is useful for certain energy storage applications, and has been found to be particularly advantageous for high maximum discharge capacity batteries having electrochemical voltaic cells which derive electrical energy from chemical reactions involving sulfur compounds. While the present invention is not necessarily limited to such applications, various aspects of the invention may be appreciated through a discussion of various examples using this context.

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from a series of examples, as described below. The embodiments on which these examples are based are representative only. The selection of those embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims and their equivalents. The significance of the examples can be better understood by comparing the results obtained therefrom with potential results which can be obtained from tests or trials that may be or may have been designed to serve as controlled experiments and provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one or at least one and the singular also includes the plural unless it is obvious that it is meant otherwise.

The meaning of abbreviations and certain terms used herein is as follows: “Å” means angstrom(s), “g” means gram(s), “mg” means milligram(s), “μg” means microgram(s), “L” means liter(s), “mL” means milliliter(s), “cc” means cubic centimeter(s), “cc/g” means cubic centimeters per gram, “mol” means mole(s), “mmol” means millimole(s), “M” means molar concentration, “wt. %” means percent by weight, “Hz” means hertz, “mS” means millisiemen(s), “mA” mean milliamp(s), “mAh/g” mean milliamp hour(s) per gram, “mAh/g S” mean milliamp hour(s) per gram sulfur based on the weight of sulfur atoms in a sulfur compound, “V” means volt(s), “x C” refers to a constant current that may fully charge/discharge an electrode in 1/x hours, “SOC” means state of charge, “SEI” means solid electrolyte interface formed on the surface of an electrode material, “kPa” means kilopascal(s), “rpm” means revolutions per minute, “psi” means pounds per square inch, “maximum discharge capacity” is the maximum milliamp hour(s) per gram of a positive electrode in a Li—S cell at the beginning of a discharge phase (i.e., maximum charge capacity on discharge), “coulombic efficiency” is the fraction or percentage of the electrical charge stored in a rechargeable battery by charging and is recoverable during discharging and is expressed as 100 times the ratio of the charge capacity on discharge to the charge capacity on charging, “pore volume” (i.e., Vp) is the sum of the volumes of all the pores in one gram of a substance and may be expressed as cc/g, “porosity”(i.e., “void fraction”) is either the fraction (0-1) or the percentage (0-100%) expressed by the ratio: (volume of voids in a substance)/(total volume of the substance).

As used herein, and unless otherwise stated, the term “cathode” is used to identify a positive electrode and “anode” to identify the negative electrode of a battery or cell. The term “battery” is used to denote a collection of one or more cells arranged to provide electrical energy. The cells of a battery can be arranged in various configurations (e.g., series, parallel and combinations thereof).

As used herein, and unless otherwise stated, the term “sulfur compound” is used to identify any compound that includes at least one sulfur atom, such as elemental sulfur and other sulfur compounds, such as lithiated sulfur compounds such as disulfide compounds and polysulfide compounds. For further details on examples of sulfur compounds particularly suited for lithium batteries, reference is made to “A New Entergy Storage Material: Organosulfur Compounds Based on Multiple Sulfur-Sulfur Bonds”, by Naoi et al., J. Electrochem. Soc., Vol. 144, No. 6, pp. L170-L172 (June 1997), which is incorporated herein by reference in its entirety.

As used herein, and unless otherwise stated, the term “turbostratic” is used to identify carbon having a macromolecular structure characterized by having two dimensional carbon sheets which are stacked and the carbon sheets have slipped sideways relative to each other. In turbostratic carbon, the basal planes of the carbon sheets have slipped out of alignment relative to each other. Turbostratic carbon can be compared as a variant of “graphite”. Graphite is carbon having a macromolecular structure which is also characterized by two-dimensional carbon sheets which are stacked. However, in graphite the macromolecular structure is stably ordered in three-dimensions and the stacked layers are associated with a stacking sequence. In both graphite and turbostratic carbon, the carbon sheets are stacked into carbon layers. However turbostratic carbon and graphite differ in the degree their respective stacking is ordered. In turbostratic carbon, the carbon layers have sufficient freedom to randomly translate relative to each other and rotate about the normal of the carbon layers. The translation and rotation of the carbon layers in turbostratic carbon changes interlayer spacing between the carbon layers and/or the shape of the carbon layers, at an atomic scale perspective, in the macromolecular structure. By way of contrast, graphite is characterized as a having a stable three dimensional macromolecular structure having a fully ordered parallel stacking sequence with a higher degree of crystallinity. Also, graphitic carbon often has a lower surface area than turbostratic carbon. Turbostratic carbon and graphite are both distinct from “graphene” which is only a single layer of carbon.

As used herein, and unless otherwise stated, the term “graphitic” is used to identify carbon having a macromolecular structure characterized by graphite.

According to the principles of the invention, as demonstrated in the following examples and embodiments, there is a C—S composite, and there are also compositions and methods of making a composition. There are layerings and methods of making a layering. And there are electrodes and methods of making an electrode. According to an example, the composition may include a C—S composite comprising a carbon powder having sulfur compound situated within porous regions of the carbon powder. The C—S composite, when used in a composition, may be combined with a polymeric binder to form the composition, according to an embodiment. In another embodiment, the composition may also include a carbon black which may be conductive. The C—S composite may be formed such that the sulfur compound weight percentage of the C—S composite is greater than zero. In an embodiment, the sulfur compound weight percentage of the C—S composite may be from about 5 to 95. In another embodiment, the sulfur compound weight percentage of the C—S composite may be from about 10 to 88. In yet another embodiment, the sulfur compound the sulfur compound weight percentage of the C—S composite may be from about 50 to 85. Other sulfur compound loadings may also be used and various processes, described in greater detail below, may be utilized to situate the sulfur compound within porous regions the carbon powder to make the C—S composite.

The composition may be made through various processes which combine components in the composition. According to an embodiment, the components may simply be combined to form a composition which may then be incorporated into an electrode structure. A positive electrode in a Li—S battery incorporating a composition comprising the C—S composite, according to the principles of the invention, demonstrates a high maximum discharge capacity and high sulfur utilization.

In other embodiments, components of the composition, comprising the C—S composite, may be combined with a solvent and applied to a surface of a substrate to form a layering. The layering may be formed in successive coating steps in a sequential coating process. In an embodiment, the layering may form an electrode incorporating the composition in the layering. Compositions, according to the principles of the invention, may be applied in successive coating steps to form a layering and/or an electrode having the same or varying compositions and/or varying C—S composites. The various compositions and various C—S composites may be applied in different and/or separate steps of the successive coating steps. The sequential coating process may also include one or more drying steps to remove solvent from the composition, the layering and/or the electrode. By the successive coating steps, the layering may be built up to a desired thickness and utilized as a high maximum discharge capacity positive electrode in a cell of a Li—S battery. The maximum discharge capacity and the sulfur utilization associated with the positive electrode in a Li—S cell is surprisingly high and the electrode without structural difficulties. Without being bound by any particular theory, the high maximum discharge capacity observed on discharge in a positive electrode made with a layering structure may be a direct consequence of the successive coating process.

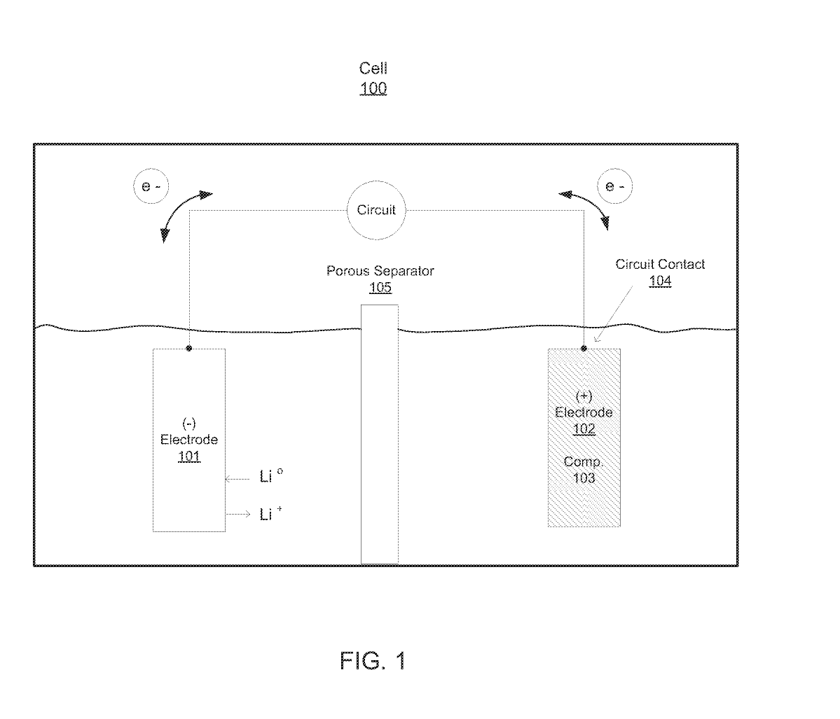

Referring to FIG. 1, depicted is a cell 100, which is a Li—S cell for a Li—S battery. Cell 100 includes a positive electrode 102 incorporating a composition 103, according to the principles of the invention. The cell 100 also includes a lithium containing negative electrode 101 and a porous separator 105. The positive electrode 102 includes a circuit contact 104. The circuit contact 104 provides a conductive conduit for the positive electrode 102 to a circuit coupling the negative electrode 101 and the positive electrode 102. The positive electrode 102 is operable in conjunction with the negative electrode 101. A carbon powder having a high surface area and a high pore volume may be utilized in the making a C—S composite in the composition 103. Sulfur compound, such as elemental sulfur, lithium sulfide, and combinations of such, may be introduced to the porous regions within the carbon powder to form a C—S composite having a weight percent sulfur compound. The C—S composite is combined with polymeric binder, and optionally carbon black and other optional components to form the composition 103. The composition 103 is incorporated into the positive electrode 102 which is utilized in the cell 100.

The carbon in the carbon powders used for making the C—S composite, according to the principles of the invention, is generally turbostratic carbon or carbon that is turbostratic in nature. Graphitic carbon may also be used, although turbostratic carbon is preferred.

Carbon suitable for use herein in making the C—S composite has a macromolecular structure characterized by having two dimensional carbon sheets which are stacked. According to an embodiment, the carbon sheets have slipped sideways relative to each other. According to another embodiment, the carbon sheets are stacked into carbon layers and the macromolecular structure of the carbon is ordered in at least two dimensions. In another embodiment, the macromolecular structure of the carbon is ordered in three dimensions and a stacking sequence is associated with the stacked carbon layers. In another embodiment, the basal planes of the carbon sheets have slipped out of alignment relative to each other in the macromolecular structure of the carbon. In another embodiment, the carbon layers in the macromolecular structure of the carbon have sufficient freedom to randomly translate relative to each other and rotate about a normal of the carbon layers. In another embodiment, the translation and rotation of the carbon layers may change interlayer spacing between the carbon layers and/or the shape of the carbon layers, at an atomic scale perspective, in the macromolecular structure of the carbon.

Graphitic carbon may also be used in making the C—S composite. In an embodiment, the carbon has a macromolecular structure which is characterized by having two-dimensional carbon sheets which are stacked in a stacking sequence and the macromolecular structure is ordered in three-dimensions. In another embodiment, the macromolecular structure of the carbon is characterized as a having a stable three dimensional structure in a fully ordered parallel stacking sequence. In another embodiment, the carbon has a degree of crystallinity. In yet another embodiment, the carbon layer stacking order is more highly ordered than turbostratic carbon.

A representative carbon powder with turbostratic carbon is KETJENBLACK EC-600JD, distributed by Akzo Nobel having an approximate surface area of 1400 m²/g BET (Product Data Sheet for KETJENBLACK EC-600JD, Akzo Nobel) and an approximate pore volume of 4.07 cc/gram, as determined according to the BJH method, based on a cumulative pore volume for pores ranging from 17-3000 angstroms. In the BJH method, nitrogen adsorption/desorption measurements were performed on ASAP model 2400/2405 porosimeters (Micrometrics, Inc., No. 30093-1877). Samples were degassed at 150° C. overnight prior to data collection. Surface area measurements utilized a five-point adsorption isotherm collected over 0.05 to 0.20 p/p₀ and were analyzed via the BET method, described in Brunauer et al., J. Amer. Chem. Soc., v. 60, no. 309 (1938), and incorporated by reference herein in its entirety. Pore volume distributions utilized a 27 point desorption isotherm and were analyzed via the BJH method, described in Barret et al., J. Amer. Chem. Soc., v. 73, no. 373 (1951), and incorporated by reference herein in its entirety. Additional commercially available carbon powders which may be utilized include KETJENBLACK 300: approximate pore volume 1.08 cc/g (Akzo Nobel) CABOT BLACK PEARLS: approximate pore volume 2.55 cc/g, (Cabot), PRINTEX XE-2B: approximate pore volume 2.08 cc/g (Orion Carbon Blacks, The Cary Company). Other sources of such carbon powders are known to those having ordinary skill in the art.

Other porous carbon materials suitable for use herein may be manufactured or synthesized using known processes, as desired, for their pore volume, surface area and other features. Porous carbon materials suitable for use herein include templated carbons. Templated carbon has a synthesized carbon microstructure which is complementary to an inorganic template used in making the templated carbon. Templated carbon materials are demonstrated in co-assigned and co-pending U.S. Patent Application Ser. No. 61/587,805, filed on Jan. 18. 2012, based on Attorney Docket No.: CL-5409, which is incorporated by reference herein in its entirety.

Carbon powders which are suitable to be utilized herein include those having a surface area of about 100 to 4,000 m²/g carbon powder, about 200 to 3,000 m²/g, about 300 to 2,500 m²/g, about 500 to 2,200 m²/g, about 700 to 2,000 m²/g, about 900 to 1,900 m²/g, about 1,100 to 1,700 m²/g and about 1,300 to 1,500 m²/g carbon powder. Carbon powders which are suitable to be utilized herein include those having a surface area of about 600 m²/g, 800 m²/g, 1,000 m²/g, 1,200 m²/g, 1,400 m²/g, 1,600 m²/g, 1,800 m²/g, 2,000 m²/g, 2,200 m²/g, 2,400 m²/g, 2,600 m²/g, 2,800 m²/g, 3,000 m²/g, 3,200 m²/g, 3,400 m²/g, 3,600 m²/g, 3,800 m²/g, and 4.000 m²/g carbon powder.

Carbon powders which are suitable to be utilized herein also include those having a pore volume ranging from about 0.25 to 10 cc/g carbon powder, from about 0.7 to 7 cc/g, from about 0.8 to 6 cc/g, from about 0.9 to 5.5 cc/g, from about 1 to 5.2 cc/g, from about 1.1 to 5.1 cc/g, from about 1.2 to 5 cc/g, from about 1.4 to 4 cc/g, and from about 2 to 3 cc/g. A particularly useful carbon powder is one having a pore volume that is greater than 1.2 cc per gram and less than 5 cc per gram carbon powder. Carbon powders which are suitable to be utilized herein include those having a pore volume of about 1.4 cc/g, 1.8 cc/g, 2.2 cc/g, 2.4 cc/g, 2.8 cc/g, 3.2 cc/g, 3.6 cc/g, 4.0 cc/g, 4.4 cc/g, 4.8 cc/g, 5.2 cc/g, 5.6 cc/g, 6.0 cc/g, 6.4 cc/g, and 6.8 cc/g carbon powder.

Sulfur compounds which are suitable for use in making the C—S composite in the composition 103 include macromolecular sulfur in its various allotropic forms and combinations thereof, such as “elemental sulfur”. Elemental sulfur is a common name for a combination of sulfur allotropes such as puckered S₈ rings, and often comprising smaller puckered rings of sulfur. Other sulfur compounds which are suitable are compounds containing sulfur and one or more other elements.

A representative sulfur compound is elemental sulfur distributed by Sigma Aldrich as “Sulfur”, (Sigma Aldrich, 84683). Other sources of such sulfur compounds are known to those having ordinary skill in the art. In addition, lithiated sulfur compounds such as, for example, Li₂S or Li₂S₂ may also be used.

Polymeric binders which may be utilized for making the composition 103 include polymers exhibiting chemical resistance, heat resistance as well as binding properties, such as polymers based on alkylenes, oxides and/or fluoropolymers. These polymers include polyethylene oxide (PEO), polyisobutylene (PIB), and polyvinylidene fluoride (PVDF). A representative polymeric binder is polyethylene oxide (PEO) with an average M_{w} of 600,000 distributed by Sigma Aldrich as “Poly(ethylene oxide)”, (Sigma Aldrich, 182028). Another representative polymeric binder is polyisobutylene (PIB) with an average M_{w} of 4,200,000 distributed by Sigma Aldrich as “Poly(isobutylene)”, (Sigma Aldrich, 181498). Polymeric binders which are suitable for use herein are also described in U.S. Published Patent Application No. US2010/0068622, which is incorporated by reference herein in its entirety. Other sources of polymeric binders are known to those having ordinary skill in the art.

Carbon blacks which are suitable for making the cathode composition include carbon substances exhibiting electrical conductivity and generally having a lower surface area and lower pore volume relative to the carbon powders described above. Carbon blacks typically are colloidal particles of elemental carbon produced through incomplete combustion or thermal decomposition of gaseous or liquid hydrocarbons under controlled conditions. Other conductive carbons which are also suitable are based on graphite. Suitable carbon blacks include acetylene carbon blacks which are preferred. A representative carbon black is SUPER C65 distributed by Timcal Ltd. and having BET nitrogen surface area of 62 m²/g carbon black measured by ASTM D3037-89. Other commercial sources of carbon black, and methods of manufacturing or synthesizing them, are known to those having ordinary skill in the art. Carbon blacks which may be utilized to make the composition 103 include carbon substances exhibiting electrical conductivity and generally having a lower surface area and lower pore volume relative to the carbon powder described above.

Carbon blacks which are suitable to be utilized herein include those having a surface area ranging from about 10 to 250 square meters per gram carbon black, about 30 to 200 square meters per gram, about 40 to 150 square meters per gram, about 50 to 100 square meters per gram and about 60 to 80 square meters per gram carbon black.

The C—S composite includes a porous carbon material, such as carbon powder, and containing the sulfur compound situated in the carbon microstructure of the carbon powder. The amount of sulfur compound which may be contained in the C—S composite (i.e., the sulfur loading in terms of the weight percentage of sulfur compound, based on the total weight of the C—S composite, is dependent to an extent on the pore volume of the carbon powder. Accordingly, as the pore volume of the carbon powder increases, higher sulfur loading with more sulfur compound is possible. Thus, a sulfur compound loading of, for example, about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 85 wt. %, 90 wt. % or 95 wt. % may be used. Ranges among these amounts define embodiments which may be used.

The composition 103 may include various weight percentages of C—S composite and/or polymeric binder. The composition 103 may optionally include carbon black in addition to the C—S composite and polymeric binder. The C—S composite is generally present in the composition 103 in an amount which is greater than 50 weight % of the composition 103. Higher loading with more C—S composite is possible. Thus, a C—S composite loading of, for example, about 55 wt. %, 60 wt. %, 65 wt. %, 70 wt. %, 75 wt. %, 80 wt. %, 85 wt. %, 90 wt. %, 95 wt. %, 98 wt. %, or 99 wt. % C—S composite may be used. According to an embodiment, about 50 to 99 wt. % C—S composite may be used. In another embodiment, about 70 to 95 wt. % C—S composite may be used. Ranges among these amounts define embodiments which may be used.

The polymeric binder is generally present in the composition 103 in an amount which is greater than 1 wt. % of the composition 103. Higher loading with more polymeric binder is possible. Thus, a polymeric binder loading of, for example, about 2 wt. %, 3 wt. %, 4 wt. %, 5 wt. %, 6 wt. %, 8 wt. %, 9 wt. %, 10 wt. %, 12 wt. %, 14 wt. %, 16 wt. %, or 17.5 wt. % polymeric binder may be used. According to an embodiment, about 1 to 17.5 wt. % polymeric binder may be used. In another embodiment, about 4 to 12 wt. % polymeric binder may be used. In another embodiment, about 1 to 9 wt. % polymeric binder may be used. Ranges among these amounts define embodiments which may be used.

According to an embodiment, carbon black may optionally be present in the composition 103 in an amount which is greater than about 0.01 wt. % of the composition 103. Higher loading with more carbon black is possible. Thus, a carbon black loading of, for example, about 0.1 wt. %, 1 wt. %, 2 wt. %, 3 wt. %, 4 wt. %, 5 wt. %, 6 wt. %, 8 wt. %, 10 wt. %, 12 wt. %, 14 wt. %, 15 wt. %, or 20 wt. % carbon black may be used. According to an embodiment, about 0.01 to 15 wt. % carbon black may be used. In another embodiment, about 5 to 10 wt. % carbon black may be used. Ranges among these amounts define embodiments which may be used.

The C—S composite may made by various methods, such as by simply mixing, such as by dry grinding, the carbon powder with the sulfur compound. According to an embodiment, the C—S composite may also be made by various compositing processes for introducing the sulfur compound into the microstructure of the carbon powder utilizing such vehicles as heat, pressure, liquid (e.g., dissolution of sulfur compound in carbon disulfide and impregnation by contacting the solution with the carbon powder), etc. Useful methods for introducing sulfur compound into the carbon powder include melt imbibement and vapor imbibement. These are compositing processes for introducing the sulfur compound into the microstructure of the carbon powder utilizing such vehicles as heat, pressure, liquid.

In melt imbibement, a sulfur compound, such as elemental sulfur can be heated above its melting point (about 113° C.) while in contact with the carbon powder to impregnate it. The impregnation may be accomplished through a direct process, such as a melt imbibement of elemental sulfur, at a raised temperature, by contacting the sulfur compound and carbon at a temperature above 100° C., such as 160° C.

A useful temperature range is 120° C. to 170° C. Another imbibement process which may be utilized is vapor imbibement which involves deposition of sulfur vapor. The sulfur compound may be raised to a temperature above 200° C., such as 300° C. At this temperature, the sulfur compound is vaporized and placed in proximity with, but not necessarily in direct contact with the carbon powder.

These processes may be combined. For example, melt imbibement process can be followed by a higher temperature process. Alternatively, the sulfur compound can be dissolved in carbon disulfide to form a solution and the C—S composite can be formed by contacting this solution with the carbon powder. The C—S composite is prepared by dissolving sulfur compounds, such as elemental sulfur and lithium sulfide, in non-polar solvents such as toluene or carbon disulfide and contacted with the porous carbon powder. The solution or dispersion can be optionally contacted at incipient wetness to promote an even deposition of the sulfide compound into the pores of the carbon powder. Incipient wetness is a process in which the total liquid volume exposed to the porous carbon does not exceed the volume of the pores of that carbon material. The contacting process can involve sequential contacting and drying steps to increase the loading of the sulfur compound.

Sulfur compound may also be introduced to the carbon powder by other methods. For example, sodium sulfide (Na₂S) can be dissolved in an aqueous solution to form sodium polysulfide. The polysulfide can be acidified to precipitate the sulfur compound in the carbon powder. In this process, the composite may require thorough washing to remove salt byproducts. Suitable introducing methods include melt imbibement and vapor imbibement. One method of melt imbibement includes heating elemental sulfur (Li₂S will not melt under these conditions) and carbon powder at about 120° C. to about 170° C. in an inert gas, such as nitrogen. A vapor imbibement method may also be utilized. In the vapor imbibement method, sulfur vapor may be generated by heating a sulfur compound, such as elemental sulfur, to between the temperatures of about 120° C. and 400° C. for a period of time, such as about 6 to 72 hours in the presence of the carbon powder. Other examples of melt imbibement and vapor imbibement are demonstrated in the examples below and in co-assigned and co-pending U.S. Patent Application Ser. No. 61/587,805, filed on Jan. 18. 2012, based on Attorney Docket No.: CL-5409, which is incorporated by reference above.

According to an embodiment, a C—S composite formed by a compositing process may be combined with a polymeric binder, and optionally a carbon black by conventional mixing or grinding processes. A solvent, preferably an organic solvent, such as toluene, alcohol, or n-methylpyrrolidone (NMP) may optionally be utilized depending on the polymeric binder system. The solvent should preferably not react with the binder so as to break the polymeric binder down, or significantly alter it. Conventional mixing and grinding processes are demonstrated in comparative examples A and B below. Other conventional mixing and grinding processes are known to those having ordinary skill in the art. The ground or mixed components may form a composition 103, according to an embodiment, which may be processed or incorporated or formed into a positive electrode.

According to another embodiment, a layering or an electrode incorporating a composition may be derived through a layering process to form the layering or the electrode. The layering process may utilize, for example, a carbon powder having a pore volume greater than 1.2 cc/g in a C—S composite. The layering and/or the electrode may be formed through the application of one or several individual layers on a surface of a detachable substrate.

The individual layers in a spray coated layering/electrode may have the same or different proportions of different components. For example, different sets of materials with different components and different proportions of components may be prepared and applied in combination to form a layering/electrode. One or more components may be completely absent from any one material applied this way. The different materials may be applied using different coating apparatuses and different application techniques. In addition, each individual coating in a layering may include a composition which is different from the compositions in the other coatings of the layering with respect to one or more components, measures of a component, etc. For example, a first coating may include C—S composite and no polymeric binder while a second coating may only include polymeric binder and no C—S composite. In another example, the respective compositions for the respective coatings in a layering are all different. In yet another example, one composition is used for half the coatings in a layering and a variety of compositions are used in the other coatings. In another example, every coating in a layer may include a different composition, etc.

For example, two materials may be prepared with different C—S composites and/or different amounts of C—S composites. In this example, the respective C—S composites in the two materials may have carbon powders with differing physical properties, sulfur compound loadings, etc. This may be applied in alternate passes of a spray coating to for a layering electrode with an averaging of the two materials throughout or with localized concentrations of one and/or another material. The components in different sets of materials may vary according to multiple parameters, such as respective polymeric binders and their weight percentages, respective C—S composites and their weight percentages, respective carbon powders and their weight percentages and sulfur compound species and their weight percentages in the respective C—S composites of the different materials.

The different materials may be applied separately or in alternating sequences. In addition, they may include optional components in different amounts such as conductive carbon black, or an inert substance such as a pigment. It is possible to vary any ingredient, such as an optional low surface conductive carbon in each of the layers. For example, a variation can be an absence of all conductive carbon, such as, for example, in the layer closest to the current collector, and the weight percentage can increase as the layering or electrode is built up moving away from the current collector. So, each layer can have a different composition, such as by varying C—S composite types or combinations of C—S composite types, polymeric binder types or combinations of polymeric binders, conductive carbon types or combinations of conductive carbon types. The number of possibilities is without any substantial limit.

Also, a porogen (i.e., a void or pore generator) may be included within the layers themselves in the positive electrode. A porogen is any additive which can be removed by a chemical or thermal process to leave behind a void, changing the pore structure of the layering or electrode. This level of porosity control may be utilized in terms of managing mass transfer in a laying or electrode layer. For example, a porogen may be a carbonate, such as calcium carbonate powder, which is added to an ink slurry applied in a layer and then coated in combination with other components in the ink slurry, such as C—S composite, polymeric binder and an optional conductive carbon, onto an aluminum foil current collector to form a layering or electrode. A porogen may also be added in intervening layers and between layers containing the C—S composite. It may be desirable to add the porogen in higher concentrations closer to the current collector to create a gradient in the direction of the thickness of the layering or electrode. Once the porogen is in place in the formed layering or electrode, it may then be removed from by washing with dilute acid to leave a void or pore. The type of porogen and the amount can be varied in each layer to control the porosity of the layering or electrode.

An individual layer may cover part or all of an area on the surface. In an example, the coating may be applied in a Raster scan order over part or all of an area and involve multiple passes of spray coating over the area to form one or more coatings. Spray coating to build-up a layering or electrode may include a few or hundreds of passes from a spray coating device. A single pass may be very small or very large, and involve small or large amounts of mixture comprising varying amounts of composition and solvent which is laid down by spraying particles of the mixture. The particle size of the particles in spray may vary and is generally on the order of 0.1 to 0.5 microns to as much as 1 micron. A single pass may deliver a small amount of material to the surface as a coating. For instance, if the final electrode contains 2.5 mg/cm² of applied material after drying, each single pass may only deliver as little as 6 micrograms/cm² of material after drying. The coatings may be provided cumulatively in greater or lesser amounts of applied material in the passes of the spray coating device, as desired. Generally, coatings applied with greater amounts of material applied may be utilized. It may be preferable in these circumstances to utilize some combination of time, heating or drying, subsequent to each pass or after some number of passes, in forming the layering.

The composition 103 may be applied in the coating to form a layering. For example, the ratio of binder to C—S composite in terms of composition weight amount may vary in different coatings of a layering. Furthermore, the sulfur compound weight percentage in the C—S composite may vary in different coatings. The C—S composite or binder weight percentages in the composition 103 may also vary. The composition weight percentages of the C—S composite and binder may vary together with or separately from the weight percentage of the sulfur compound in the C—S composite in different coatings of a layering, etc. The type of porous carbon used in the C—S composite may vary from layer to layer. Each layer may contain one or more C—S composites, but can contain other C—S composites formed from different porous carbon powders and having different sulfur compound weight percentages in the C—S composites. The number of coatings in a layering or electrode is not limited, and is ordinarily greater than 30, but may be a single coating, or may number into the hundreds, the thousands, the millions and higher.

According to an example, coatings to form a layering may include the composition 103, comprising a C—S composite, and a binder. These components may be combined with a solvent, such as ethanol, toluene, or ethanol optionally combined with water and carbon black. The combination with a solvent provides a slurry or ink which may be applied in one or more low weight coatings to form a layering on a detachable or adhered substrate. The use of the layering process, optionally combined with the use of a high pore volume carbon powder made via a compositing process, provides a very stable and conductive host for electroactive sulfur compound in a positive electrode.

Li—S cells with electrodes made using a layering process to form a layering in a positive electrode, when lithium metal is used in a coupled negative electrode; are operable with very high discharge capacity retention. In some cases greater than 95% retention of discharge capacity is achieved after 80 discharge cycles at C/5 rates (335 mA/g S). According to other examples, the successive coatings may also be used to create alternative electrode architectures such as low coating weight layering(s) forming various components, alternating layering, or patterns on an electrode surface.

According to an example, by applying several hundred coatings, such as 300-400 coatings, to build an electrode that is about 1 mil in thickness, an improved electrode is fabricated which does not show significant cracking or delaminating from a substrate to which the coatings are applied to form the layering. In another example, after a number of coatings, such as every fourth coating, the layering may be briefly dried at an elevated temperature, such as 70° C. or higher, to effect a controlled removal of the solvent. By this controlled removal of the solvent, macroscopic shrinkage of the layering may also be controlled and electrode cracking and/or delaminating may be avoided.

According to an example, a layering or electrode may not be a continuous coating. According to another example, several hundred coatings may be employed to achieve a desired thickness. According to other examples, a drying step may be performed after every coating, or at every 20 coating, 10 coatings, etc. The dispersion or slurry for the coating can be preheated to facilitate drying. Any combination of drying steps, coating steps or sequences of such may be used to build up the layering or electrode. In another example, continuous heating of the coatings may be utilized to facilitate evaporation of solvent from the coatings in a layering. A mixture comprising the composition 103 and a solvent may be heated to facilitate evaporation of the solvent during the coating process. According to other examples, the layering process to form the layering in an electrode may utilize any coating process which involves multiple coating depositions, such as spray coating, dip coating, spin coating and air brushing.

Referring again to FIG. 1, depicted is the positive electrode 102, that may be formed incorporating a cathode composition as described above. The formed positive electrode 102 may be utilized in the cell 100 in conjunction with a negative electrode, such as the lithium-containing negative electrode 101 described above. According to different embodiments, the negative electrode 101 may contain lithium metal or a lithium alloy. In another embodiment, the negative electrode 101 may contain graphite or some other non-lithium material. According to this embodiment, the positive electrode 102 is formed to include some form of lithium, such as lithium sulfide (Li₂S), and according to this embodiment, the C—S composite may be lithiated utilizing lithium sulfide which is incorporated into the powdered carbon to form the C—S composite, instead of elemental sulfur.

A porous separator, such as porous separator 105, may be constructed from various materials. As an example, a mat or other porous article made from fibers, such as polyimide fibers, may be used as the porous separator 105. In another example, using porous laminates made from polymers such as polyvinylidene fluoride (PVDF), polyvinylidene fluoride co-hexafluoropropylene (PVDF-HFP), polyethylene (PE), polypropylene (PP), polyimide, polymer blends.

Positive electrode 102, negative electrode 101 and porous separator 105 are in contact with a lithium-containing electrolyte medium in the cell 100, such as a cell solution with solvent and electrolyte. In this embodiment, the lithium-containing electrolyte medium is a liquid. In another embodiment, the lithium-containing electrolyte medium is a solid. In yet another embodiment, the lithium-containing electrolyte medium is a gel.

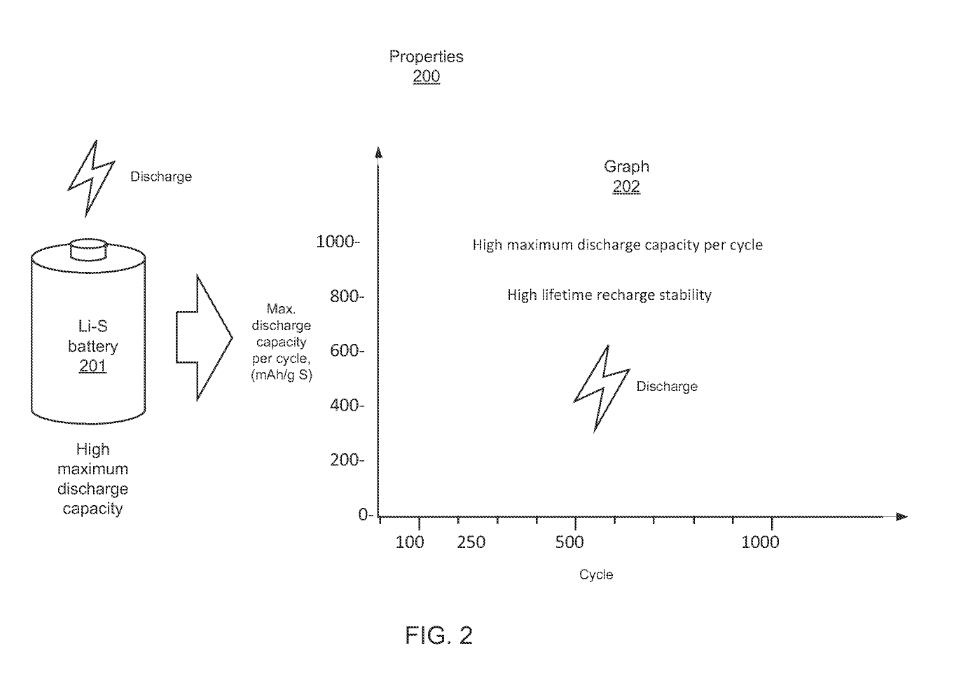

Referring to FIG. 2, depicted is a context diagram illustrating properties 200 of a Li—S battery 201 comprising a Li—S cell, such as cell 100, having a positive electrode comprising composition 103 comprising C—S composite in a layering structure, such as electrode 102. The context diagram of FIG. 2 demonstrates the properties 200 of the Li—S battery 201, having a high maximum discharge capacity. The high maximum discharge capacity appears to be directly attributable to the presence of the positive electrode comprising composition 103 comprising C—S composite in a layering structure in a Li—S cell of the battery 201. FIG. 2 also depicts a graph 202 demonstrating maximum discharge capacity per cycle of Li—S battery 201 with respect to a number of charge-discharge cycles. The Li—S battery 201 also exhibits high lifetime recharge stability and a high maximum discharge capacity per charge-discharge cycle. All these properties 200 of the Li—S battery 201 are demonstrated in greater detail below through the specific examples.

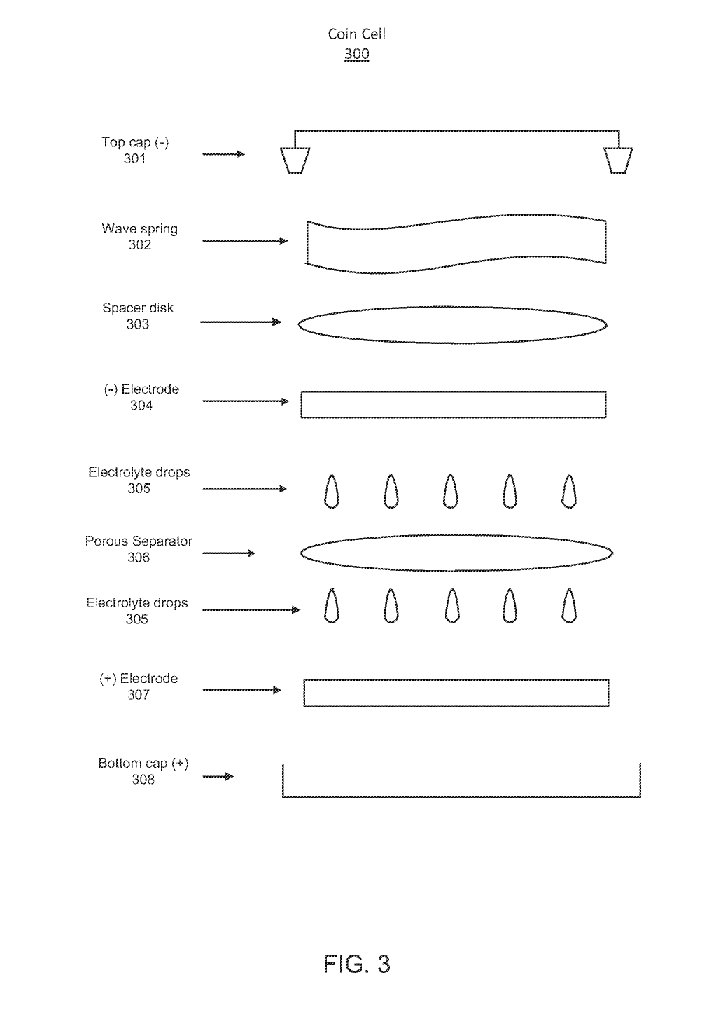

Referring to FIG. 3, depicted is a coin cell 300 which is operable as an electrochemical measuring device for testing various layering structures and variants of composition 103 comprising the C—S composite. The function and structure of the coin cell 300 are analogous to those of the cell 100 depicted in FIG. 1. The coin cell 300, like the cell 100, utilizes a lithium-containing electrolyte medium. The lithium-containing electrolyte medium is in contact with the negative electrode and the positive electrode and may be a liquid containing solvent and lithium ion electrolyte.

The lithium ion electrolyte may be non-carbon-containing. For example, the lithium ion electrolyte may be a lithium salt of such counter ions as hexachlorophosphate (PF₆⁻), perchlorate, chlorate, chlorite, perbromate, bromate, bromite, periodiate, iodate, aluminum fluorides (e.g., AlF₄⁻), aluminum chlorides (e.g. Al₂Cl₇⁻, and AlCl₄⁻), aluminum bromides (e.g., AlBr₄⁻), nitrate, nitrite, sulfate, sulfites, permanganate, ruthenate, perruthenate and the polyoxometallates.

In another embodiment, the lithium ion electrolyte may be carbon containing. For example, the lithium ion salt may contain organic counter ions such as carbonate, the carboxylates (e.g., formate, acetate, propionate, butyrate, valerate, lactacte, pyruvate, oxalate, malonate, glutarate, adipate, deconoate and the like), the sulfonates (e.g., CH₃SO₃⁻, CH₃CH₂SO₃⁻, CH₃(CH₂)₂SO₃⁻, benzene sulfonate, toluenesulfonate, dodecylbenzene sulfonate and the like. The organic counter ion may include fluorine atoms. For example, the lithium ion electrolyte may be a lithium ion salt of such counter anions as the fluorosulfonates (e.g., CF₃SO₃³¹, CF₃CF₂SO₃₋₅ CF₃(CF₂)₂SO₃³¹, CHF₂CF₂SO₃⁻ and the like), the fluoroalkoxides (e.g., CF₃O—, CF₃CH₂O³¹, CF₃CF₂O⁻ and pentafluorophenolate), the fluoro carboxylates (e.g. trifluoroacetate and pentafluoropropionate) and fluorosulfonimides (e.g., (CF₃SO₂)₂N⁻). Other electrolytes which are suitable for use herein are disclosed in U.S. Published Patent Applications 2010/0035162 and 2011/00052998 both of which are incorporated herein by reference in their entireties.

The electrolyte medium may exclude a protic solvent, since protic liquids are generally reactive with the lithium anode. Solvents are preferable which may dissolve the electrolyte salt. For instance, the solvent may include an organic solvent such as polycarbonate, an ether or mixtures thereof. In other embodiments, the electrolyte medium may include a non-polar liquid. Some examples of non-polar liquids include the liquid hydrocarbons, such as pentane, hexane and the like.

Electrolyte preparations suitable for use in the cell solution may include one or more electrolyte salts in a nonaqueous electrolyte composition. Suitable electrolyte salts include without limitation: lithium hexafluorophosphate, Li PF₃(CF₂CF₃)₃, lithium bis(trifluoromethanesulfonyl)imide, lithium bis(perfluoroethanesulfonyl)imide, lithium (fluorosulfonyl) (nonafluoro-butanesulfonyl)imide, lithium bis(fluorosulfonyl)imide, lithium tetrafluoroborate, lithium perchlorate, lithium hexafluoroarsenate, lithium trifluoromethanesulfonate, lithium tris(trifluoromethanesulfonyl)methide, lithium bis(oxalato)borate, lithium difluoro(oxalato)borate, Li₂B₁₂F₁₂₋ₓHₓ where x is equal to 0 to 8, and mixtures of lithium fluoride and anion receptors such as B(OC₆F₅)₃. Mixtures of two or more of these or comparable electrolyte salts can also be used. In one embodiment, the electrolyte salt is lithium bis(trifluoromethanesulfonyl)imide). The electrolyte salt may be present in the nonaqueous electrolyte composition in an amount of about 0.2 to about 2.0 M, more particularly about 0.3 to about 1.5 M, and more particularly about 0.5 to about 1.2 M.

### EXAMPLES

Sample coin cells were prepared according to the examples below and used to test the composition 103, and electrodes incorporating the composition 103 a coin cell. The composition and electrode of each example was cycled at room temperature between 1.5 and 3.0 V (vs. Li/Li⁰) at C/5 (based on 1675 mAh/g for the charge capacity of elemental sulfur). This is equivalent to a current of 335 mAh per gram S on the positive electrode (cathode 307). Reference is made below to the following specific examples.

### Example 1

Example 1 describes the electrochemical results for a spray coated layering/electrode incorporating a composition comprising KETJENBLACK 600 (high surface area, high pore volume carbon) C—S composite, a polyisobutylene (PIB) binder, and low surface area conductive carbon black in a weight ratio of 84/8/8 for the C—S composite/binder/carbon black in the composition.

Preparation of C—S Composite:

Approximately 1.0 g of the KETJENBLACK 600 carbon powder (KETJENBLACK EC-600JD, Akzo Nobel) surface area approximately 1400 m²/g BET (Product Data Sheet for KETJENBLACK EC-600JD, Akzo Nobel) and pore volume 4.07 cc/g (as measured by the BJH method) was placed in a 30 ml glass vial and loaded into an autoclave which had been charged with approximately 100 grams of elemental sulfur (Sigma Aldrich 84683). The carbon powder was prevented from being in physical contact with the elemental sulfur but the carbon powder had access to the sulfur vapor. The autoclave was closed, purged with nitrogen, and then heated to 300° C. for 24 hours under a static atmosphere. The final sulfur compound loading of the C—S composite was 53.7 wt. % sulfur compound.

Jar Milling of C—S Composite:

807.9 mg of the C—S composite described above, 22.53 g of toluene (EMD Chemicals) and 60 g of 5 mm diameter zirconia media were loaded into a 125 mL polyethylene bottle. The bottle was sealed, and tumbled end-over-end inside a larger jar on jar mill for 15 hours.

Preparation of Composition: 84/8/8 C—S Composite/Binder/Carbon Black Formulation:

Polyisobutylene with an average M_{w} of 4,200,000 (Sigma Aldrich 181498) was dissolved in toluene to produce a 2.0 wt. % polymer solution. 20.1 mg of conductive carbon black SUPER C65 (Timcal Ltd.) (BET nitrogen surface area of 62 m²/g measured by ASTM D3037-89) (Technical Data Sheet for SUPER C65, Timcal Ltd.) was dispersed in 998 mg of the 2.0 wt. % polyisobutylene solution and 500 mg of toluene. 5.84 g of the jar milled suspension of C—S composite/PIB binder described above was added to the SUPER C65 slurry along with 4.0 g of toluene. This mixture with about 2 wt. % solid loading was mixed for 30 minutes in an ultrasonic bath and then stirred for 3 hours. The mixture included the C—S composite/PIB binder/and carbon black in a weight ratio, based on the composite, binder and carbon black, approximating 84 wt. % C—S composite/8 wt. % binder/and 8 wt. % carbon black.

Spray Coating of Layering/Electrode:

The electrode 307 was formed by spraying the formulated mixture onto one side of a 1 mil double-sided carbon coated aluminum foil (Exopac Advanced Coatings) as a substrate for the coating or layering of the electrode 307. The dimensions of the coated area on the substrate were approximately 4 cm×4 cm. The slurry was sprayed through an air brush (BADGER PATRIOT 105) onto the substrate in a layer-by layer pattern. The substrate was heated on a 70° C. hotplate for about 10 seconds following the application of every 4 layers to the substrate surface. Once all of the slurry was sprayed onto the substrate, the formed layering/electrode was placed in a vacuum at a temperature of 70° C. for a period of 5 minutes. The dried layering/electrode was calendared between two steel rollers on a custom built device to a final thickness of approximately 1 mil.

Preparation of Electrolyte:

2.87 grams of lithium bis(trifluoromethane sulfonyl)imide (LiTFSI, Novolyte) was combined with 10 milliters of bis(2-methoxyethyl)ether (diglyme, Novolyte) to create the electrolyte solution.

Preparation of Coin Cell:

A coin cell 300 was prepared using the electrode described above as the positive electrode 307 for testing. A 14.29 mm diameter circular disk was punched from the layering/electrode and was used as the positive electrode 307. The final weight of the electrode (14.29 mm in diameter, subtracting the weight of the aluminum current collector) was 3.2 mg. This corresponds to a calculated weight of 1.43 mg of elemental sulfur on the electrode. The coin cell 300 included the positive electrode 307, a CELGARD 2300 porous separator 306 (Celgard, LLC), a 3 mil thick lithium foil negative electrode 304 (Chemetall Foote Corp.) and a few electrolyte drops 305 of the nonaqueous electrolyte sandwiched in a Hohsen 2032 stainless steel coin cell can with stainless steel spacer disk and wave spring (Hohsen Corp.). The construction involved the following sequence as shown in FIG. 3: bottom cap case 308, positive electrode 307, electrolyte drops 305, porous separator 306, electrolyte drops 305, negative electrode 304, spacer disk 303, wave spring 302 and top cap 301. The final assembly was crimped with an MTI crimper (MTI).

Testing Conditions:

Samples of the positive electrode 307 were cycled at room temperature between 1.5 and 3.0 V (vs. Li/Li⁰) at C/5 (based on 1675 mAh/g S for the charge capacity of elemental sulfur). This is equivalent to a current of 335 mAh per gram S on the positive electrode 307.

Electrochemical Evaluation:

The maximum charge capacity on discharge at cycle 10 was 951 mAh/g S, and at cycle 80 was 852 mAh/g S.

### Example 2

Example 2 describes the electrochemical results for a spray coated layering/electrode incorporating a composition comprising a KETJENBLACK 600 (high surface area, high pore volume carbon) C—S composite, a polyethyleneoxide (PEO) binder, and low surface area conductive carbon black in a weight ratio of 80/12/8 for the C—S composite/binder/carbon black in the composition.

Preparation of C—S Composite:

Approximately 1.0 g of the KETJENBLACK 600 carbon powder (KETJENBLACK EC-600JD, Akzo Nobel) surface area approximately 1400 m²/g BET (Product Data Sheet for KETJENBLACK EC-600JD, Akzo Nobel) and DBP pore volume of 4.07 cc/g (as measured by BJH method) was placed in a 30 ml glass vial and loaded into an autoclave which had been charged with approximately 100 grams of elemental sulfur (Sigma Aldrich 84683). The carbon powder was prevented from being in physical contact with the elemental sulfur powder but the carbon powder had access to the sulfur vapor. The autoclave was closed, purged with nitrogen, and then heated to 300 C for 24 hours under a static atmosphere. The final sulfur compound content of the C—S composite was 51.0 wt. % sulfur compound.

Jar Milling of C—S Composite:

769 mg of the C—S composite described above, 22.26 g of ethanol (Sigma Aldrich 459836) and 60 g of 5 mm diameter zirconia media were weighed into a 125 mL polyethylene bottle. The bottle was sealed, and tumbled end-over-end inside a larger jar on jar mill for 15 hours.

Preparation of Composition: 80/12/8 C—S Composite/Binder/Carbon Black Formulation:

Polyethylene oxide (PEO) with an average M_{w} of 600,000 (Sigma Aldrich 182028) was dissolved in acetonitrile (Sigma Aldrich 271004) to produce a 5.0 wt. % polymer solution. 56.2 mg of conductive carbon black SUPER C65 carbon (Timcal Ltd.) (BET nitrogen surface area of 62 m²/g measured by ASTM D3037-89) (Technical Data Sheet for SUPER C65, Timcal Ltd.) was dispersed in 1.68 g of the 5.0 wt. % polyethylene oxide solution, 3.14 g of deionized water and 0.8 g of ethanol. The slurry mixture was mixed with a magnetic stir bar for 15 minutes. 17.12 g of the jar milled suspension of sulfur/carbon black composite described above was added to the Super C65 slurry, along with 9.7 g of deionized water. This mixture was stirred for 90 minutes, then mixed for 30 minutes in an ultrasonic bath, and stirred again for 60 minutes. The mixture included the C—S composite/PEO binder/and carbon black in a weight ratio, based on the C—S composite, binder and carbon black, approximating 80 wt. % C—S composite/12 wt. % binder/and 8 wt. % carbon black.

Spray Coating of Layering/Electrode:

The electrode 307 was formed by spraying this formulated mixture on one side of a 1 mil double-sided carbon coated aluminum foil (Exopac Advanced Coatings). The coated area was approximately 7 cm×7 cm. The slurry was sprayed through an air brush (BADGER PATRIOT 105) onto the substrate in a layer-by layer fashion. The substrate was heated on a 70° C. hotplate for about 10 seconds following the application of every 4 layers to the substrate surface. Once all of the slurry was sprayed onto the substrate, the layering/electrode was placed in a 70° C. vacuum for a period of 5 minutes. The dried layering/electrode was calendared between two steel rollers on a custom built device to a final thickness of about 1 mil.

Preparation of Electrolyte:

2.87 grams of lithium bis(trifluoromethane sulfonyl)imide (LiTFSI, Novolyte) was combined with 10 milliters of bis(2-methoxyethyl)ether (diglyme Novolyte) to create the electrolyte solution.

Preparation of Coin Cell:

A coin cell 300 was prepared using the layering/electrode described above as the positive electrode 307 for testing. A 14.29 mm diameter circular disk was punched from the electrode 307 and was used as a positive electrode 307. The final weight of the electrode (14.29 mm in diameter, subtracting the weight of the aluminum current collector) was 4.9 mg. This corresponds to a calculated weight of 2.01 mg of elemental sulfur on the electrode. The coin cell 300 included the positive electrode 307, a CELGARD 2300 porous separator 306 (Celgard, LLC), a 3 mil thick lithium foil negative electrode 304 (Chemetall Foote Corp.) and a few electrolyte drops 305 of the nonaqueous electrolyte sandwiched in a HOHSEN 2032 stainless steel coin cell can with stainless steel spacer disk and wave spring (Hohsen Corp.). The construction involved the following sequence as shown in FIG. 3: bottom cap case 308, positive electrode 307, electrolyte drops 305, porous separator 306, electrolyte drops 305, negative electrode 304, spacer disk 303, wave spring 302 and top cap 301. The final assembly was crimped with an MTI crimper (MTI).

Testing Conditions:

Samples of the positive electrode were cycled at room temperature between 1.5 and 3.0 V (vs. Li/Li⁰) at C/5 (based on 1,675 mAh/g for the charge capacity of elemental sulfur). This is equivalent to a current of 335 mAh per gram S on the positive electrode 307.

Electrochemical Evaluation:

The maximum charge capacity on discharge at cycle 10 was 1,034 mAh/g S, and at cycle 80 was 885 mAh/g S.

### Comparative Example A

Comparative example A describes the preparation, by a draw-down technique, of an electrode incorporating a composition comprising a KETJEN 600 (high surface area, high pore volume carbon) C—S composite, a polyvinylidene difluoride (PVDF) binder, and low surface area conductive carbon black in a weight ratio of 80/12/8 for the C—S composite/binder/carbon black in the composition.

Preparation of C—S Composite:

Approximately 1.2 g of the KETJENBLACK 600 carbon powder (KETJENBLACK EC-600JD, Akzo Nobel) BET surface area approximately 1400 m²/g (Product Data Sheet for KETJENBLACK EC-600JD, Akzo Nobel) and pore volume 4.07 cc/g (as measured by the BJH method) was placed in a 30 ml glass vial and loaded into an autoclave which had been charged with approximately 100 grams of elemental sulfur (Sigma Aldrich 84683). The carbon powder was prevented from being in physical contact with the elemental sulfur but the carbon powder had access to the sulfur vapor. The autoclave was closed, purged with nitrogen, and then heated to 300° C. for 24 hours under a static atmosphere. The final sulfur compound loading of the C—S composite was 57.1 wt. % sulfur compound.

Preparation of Composition: 80/12/8 C—S Composite/Binder/Carbon Black:

Conductive carbon black SUPER C65 (Timcal Ltd.) (BET nitrogen surface area of 62 m²/g measured by ASTM D3037-89) (Technical Data Sheet for SUPER C65, Timcal Ltd.) was blended and dispersed in n-methylpyrrolidone (NMP) (Aldrich, 242799) to create a 15 wt. % slurry. 1.47 grams of polyvinylidene difluoride solution (12 wt. % of PVDF in n-methylpyrrollidone) was combined with 0.782 grams of the SUPER C65-NMP slurry and placed in a planetary centrifugal vacuum mixer, “THINKY ARE-310” (Thinky Corporation). The slurry was mixed at 2,000 rpm for approximately two minutes. To this formulation, 1.17 grams of the KETJENBLACK 600 C—S composite as described above was added along with an additional 1.58 grams of n-methylpyrrolidone (NMP) (Aldrich, 242799) and the material was mixed for a second time in the THINKY mixer for two minutes. The material included the C—S composite/PVDF binder/and carbon black in a weight ratio, based on the C—S composite, binder and carbon black, approximating 80 wt. % C—S composite/12 wt. % binder/and 8 wt. % carbon black.

Draw Down Formation of Electrode:

The electrode was formed by applying this formulation on an aluminum foil with a 15 mil drawdown blade. A 1 mil single sided carbon coated Al foil (Exopac Advanced Coatings) was used as the substrate for the draw down. The applied area was approximately 3″×4″. After drawing down the formulation, containing the C—S composite, PVDF binder and SUPER C65 carbon onto the carbon coated foil, the electrode was placed in a room temperature vacuum oven and heated to 70° C. over a period of 70 minutes. The electrode was subsequently held at 70° C. g for 20 minutes while under vacuum before cooling to room temperature under vacuum.

Electrochemical Evaluation:

The electrode cracked and delaminated, upon drying, and could not be tested in electrochemical testing.

### Comparative Example B

Comparative example B describes the preparation, by a draw-down technique, of an electrode incorporating a composition comprising a KETJENBLACK 600 (high surface area, high pore volume carbon) carbon, sulfur and a polyethylene oxide (PEO) binder in a weight ratio of 10/70/20 for the KETJENBLACK 600 carbon/sulfur/PEO binder in the composition.

Preparation of Composition: 10/70/20 Carbon Powder/Sulfur/Binder:

3.51 g of elemental sulfur (Sigma Aldrich 84683), 0.50 g of the KETJENBLACK 600 carbon powder (KETJENBLACK EC-600JD, Akzo Nobel) surface area approximately 1,400 m2/g BET (Product Data Sheet for KETJENBLACK EC-600JD, Akzo Nobel) and pore volume 4.07 cc/g (as measured by the BJH method)) and 1.0 g polyethylene oxide (PEO) with average M_{w} of 4,000,000 (Sigma Aldrich 189464) were dry ground in a FRITSCH PULVERISETTE (Fritsch, Gmbh) mill for 105 minutes. 1.2 g of the above solid mixture was combined with 3.6 g of acetonitrile (Sigma Aldrich 271004). This mixture was stirred rapidly for 8 days in a slurry. The slurry mixture included the carbon powder/sulfur/PEO binder/and carbon black in a weight ratio, based on the carbon powder, sulfur, binder and carbon black, approximating 10 wt. % carbon powder/70 wt. % sulfur/20 wt. % binder.

Draw Down Formation of Electrode:

The slurry mixture was drawn down as paste onto 1-mil carbon-coated aluminum foil (Exopac Advanced Coatings) using a 10 mil doctor blade, and the electrode was dried for 20 minutes uncovered in a fume hood. Then the electrode was further dried for 10 minutes inside a 70° C. vacuum oven. The dried electrode was calendared between two steel rollers on a custom built device to a final thickness of about 1 mil.

Preparation of Electrolyte:

2.87 grams of lithium bis(trifluoromethane sulfonyl)imide (LiTFSI, Novolyte) was combined with 10 milliters of bis(2-methoxyethyl)ether (diglyme Novolyte) to create the electrolyte solution.

Preparation of Coin Cell:

A coin cell 300 was prepared using the electrode described above as the positive electrode 307 for testing. A 14.29 mm diameter circular disk was punched from the electrode and was used as the positive electrode 307. The final weight of the electrode (14.29 mm in diameter, subtracting the weight of the aluminum current collector) is 2.4 mg. This corresponds to a calculated weight of 1.68 mg of elemental sulfur on the electrode. The coin cell 300 included the positive electrode 307, a CELGARD 2300 porous separator 306 (Celgard, LLC), a 3 mil thick lithium foil negative electrode 304 (Chemetall Foote Corp.) and a few electrolyte drops 305 of the nonaqueous electrolyte sandwiched in a HOHSEN 2032 stainless steel coin cell can with stainless steel spacer disk and wave spring (Hohsen Corp.). The construction involved the following sequence as shown in FIG. 3: bottom cap case 308, positive electrode 307, electrolyte drops 305, porous separator 306, electrolyte drops 305, negative electrode 304, spacer disk 303, wave spring 302 and top cap 301. The final assembly was crimped with an MTI crimper (MTI).

Testing Conditions:

Samples of the positive electrode 307 were cycled at room temperature between 1.5 and 3.0 V (vs. Li/Li⁰) at C/5 (based on 1675 mAh/g S for the charge capacity of elemental sulfur). This is equivalent to a current of 335 mAh per gram S on the positive electrode 307.

Electrochemical Evaluation:

The maximum charge capacity on discharge at cycle 10 was 466 mAh/g S, and at cycles 80 was 477 mAh/g S. Thus, the electrode 307 of comparative example B showed less than half of the sulfur utilization of the electrodes 307 demonstrated in examples 1 and 2.

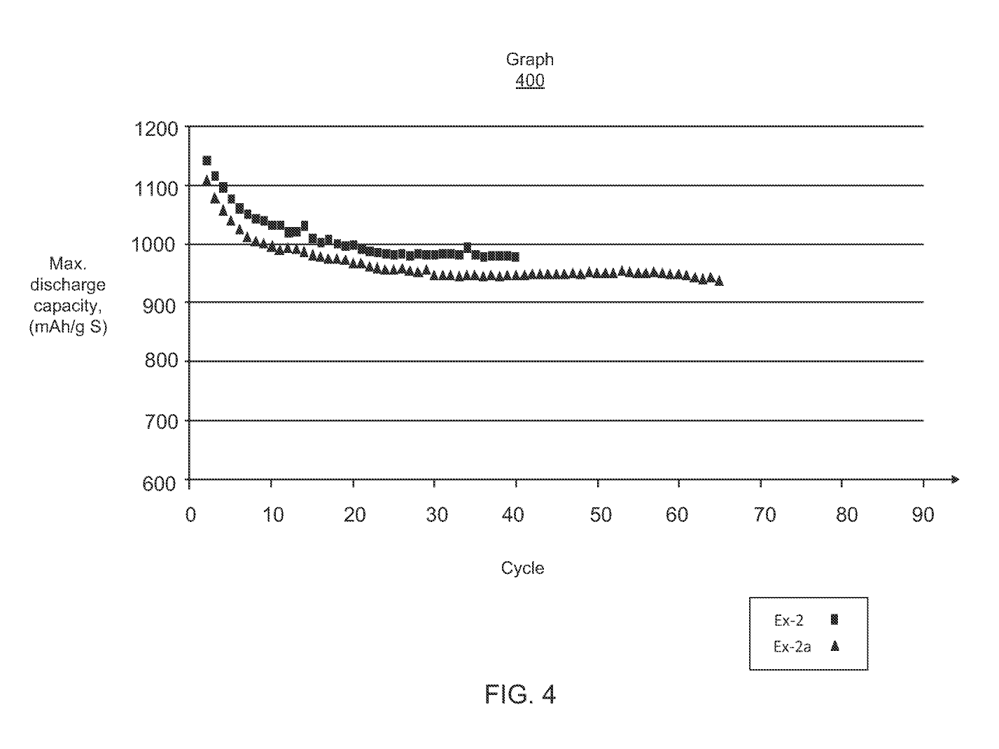

Referring to FIG. 4, depicted is a graph 400 showing maximum discharge capacities at multiple cycles for the electrochemical evaluation for two runs of the electrode 307 of example 2. The electrode 307 in example 2 was prepared from a composition 103 having an 80/12/8 C—S composite/binder/carbon black weight percentage and the C—S composite was prepared utilizing a vapor imbibement compositing process.

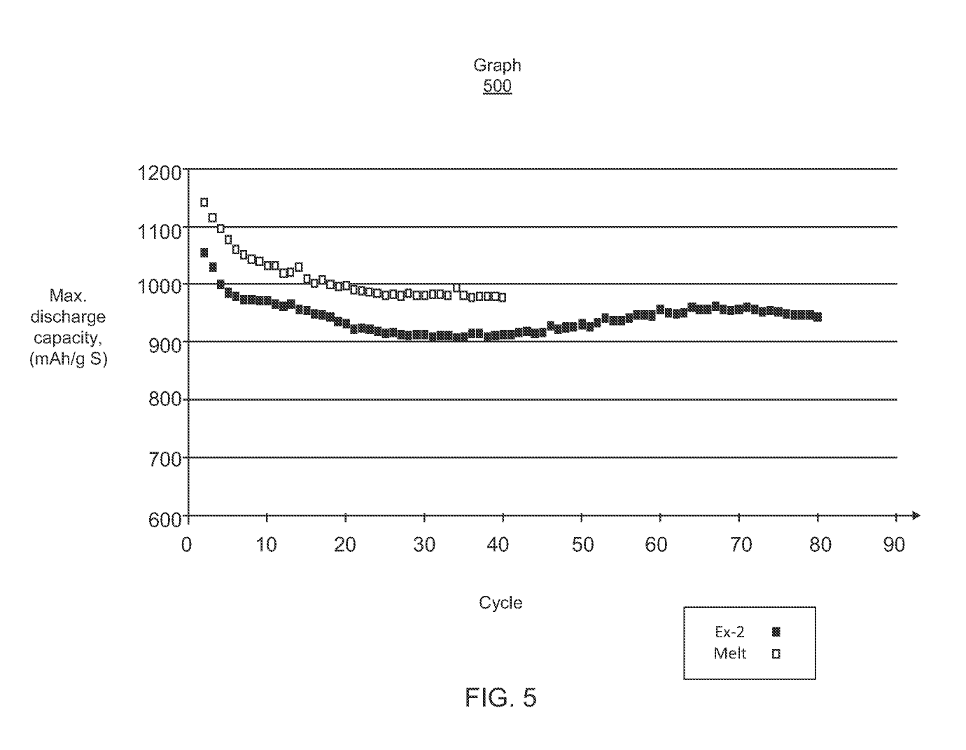

Referring to FIG. 5, depicted is a graph 500 showing discharge capacities in terms of mAh/g S at multiple cycles for the electrochemical evaluation for a run of cycles of the electrode 307 prepared according to example 2 utilizing a vapor imbibement compositing process. Also shown is data obtained from the electrochemical evaluation of a similar electrode incorporating a C—S composite prepared utilizing a melt-imbibement compositing process. The data in the graph 500 show that a composition, such as composition 103, and a positive electrode, such as positive electrode 102, in accordance with the principles of the invention shows high maximum charge capacity on discharge, high sulfur utilization and significant stability.

Utilizing a Li—S cell incorporating a positive electrode with a composition 103 or a layering structure provides a high maximum charge capacity Li—S battery. Li—S cells incorporating positive electrode with a composition 103 or a layering structure may be utilized in a broad range of Li—S battery applications in providing a source of potential power for many household and industrial applications. The Li—S batteries incorporating Li—S cells with these positive electrode are especially useful as power sources for small electrical devices such as cellular phones, cameras and portable computing devices and may also be used as power sources for car ignition batteries and for electrified cars.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art who are not familiar with patent or legal terms or phraseology, to determine quickly from a cursory inspection the nature and essence of this technical disclosure. The Abstract is not intended to be limiting as to the scope of the present invention in any way.

Although described specifically throughout the entirety of the disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to figures and data described herein, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A composition comprising:
about 1 to 17.5 wt. % polymeric binder; and
about 50 to 99 wt. % carbon-sulfur composite, the carbon-sulfur composite comprising
carbon powder characterized by having a surface area of about 50 to 4,000 square meters per gram and a pore volume of about 0.5 to 6 cubic centimeters per gram,
wherein the carbon powder comprises carbon having a macromolecular structure ordered in at least two dimensions and characterized by having two-dimensional carbon sheets which are stacked into carbon layers, and
about 5 to 95 wt. % sulfur compound in the carbon-sulfur composite.

2. The composition of claim 1, wherein the macromolecular structure is ordered in two dimensions or wherein the macromolecular structure is ordered in three dimensions and the carbon layers are associated with a stacking sequence of the two dimensional carbon sheets.

3. The composition of claim 1, wherein the carbon sheets are associated with basal planes that have slipped out of alignment relative to each other in the macromolecular structure.

4. The composition of claim 1, wherein the carbon powder is characterized by having a surface area of about 900 to 1,900 square meters per gram and a pore volume of about 1.2 to 5 cubic centimeters per gram.

5. The composition of claim 1, wherein the carbon-sulfur composite is made using a compositing process comprising at least one compositing step, a compositing step in the at least one compositing step comprising heating the sulfur compound and introducing the heated sulfur compound into the carbon powder to make the carbon-sulfur composite.

6. A method for making a composition, the method comprising:
combining
about 1 to 17.5 wt. % polymeric binder; and
about 50 to 99 wt. % carbon-sulfur composite, the carbon-sulfur composite comprising
carbon powder characterized by having a surface area of about 50 to 4,000 square meters per gram and a pore volume of about 0.5 to 6 cubic centimeters per gram,
wherein the carbon powder comprises carbon having a macromolecular structure ordered in at least two dimensions and characterized by having two-dimensional carbon sheets which are stacked into carbon layers, and
about 5 to 95 wt. % sulfur compound in the carbon-sulfur composite.

7. A layering comprising:
a plurality of coatings, wherein respective coatings in the plurality of coatings comprise respective compositions based on at least one composition, wherein the respective compositions comprise at least one of
at least one polymeric binder,
at least one carbon-sulfur composite, comprising
at least one carbon powder, and
at least one sulfur compound, and
at least one component other than the at least one polymeric binder and the at least one carbon-sulfur composite.

8. The layering of claim 7, wherein the layering is made using a layering process comprising a plurality of coating steps, a coating step in the plurality comprising applying a respective composition of the respective compositions combined with a solvent to a surface.

9. A method for making a layering, comprising:
combining at least one solvent with at least one composition to make at least one mixture for a plurality of coatings, wherein respective coatings in the plurality of coatings comprise respective compositions based on the least one composition, wherein the respective compositions comprise at least one of
at least one polymeric binder, and
at least one carbon-sulfur composite, comprising
at least one carbon powder, and
at least one sulfur compound, and
at least one component other than the at least one polymeric binder and the at least one carbon-sulfur composite; and
applying the at least one mixture to make a plurality of coatings forming a layering.

10. An electrode comprising:
a circuit contact; and
a composition comprising
about 1 to 17.5 average wt. % of at least one polymeric binder; and
about 50 to 99 average wt. % of at least one carbon-sulfur composite, the at least one carbon-sulfur composite comprising
at least one carbon powder characterized by having a surface area of about 50 to 4,000 square meters per gram and a pore volume of about 0.5 to 6 cubic centimeters per gram,
wherein the at least one carbon powder comprises carbon having a macromolecular structure ordered in at least two dimensions and characterized by having two-dimensional carbon sheets which are stacked into carbon layers, and
about 5 to 95 average wt. % of at least one sulfur compound in the at least one carbon-sulfur composite.

11. An electrode comprising:
a circuit contact; and
a layering comprising
a plurality of coatings, wherein respective coatings in the plurality of coatings comprise respective compositions based on at least one composition, wherein the respective compositions comprise at least one of
at least one polymeric binder,
at least one carbon-sulfur composite, comprising
at least one carbon powder, and
at least one sulfur compound, and
at least one component other than the at least one polymeric binder and the at least one carbon-sulfur composite.

12. The electrode of claim 11, wherein the layering is made using a layering process comprising a plurality of coating steps, a coating step in the plurality comprising applying a respective composition of the respective compositions combined with a solvent to a surface.

13. A method for using a cell, comprising at least one step from the plurality of steps comprising
converting chemical energy stored in the cell into electrical energy; and
converting electrical energy into chemical energy stored in the cell, wherein the cell comprises
a negative electrode,
a circuit coupling the positive electrode with the negative electrode,
an electrolyte medium, and
a positive electrode, wherein the positive electrode comprises at least one of
(a) a layering comprising
a plurality of coatings, wherein respective coatings in the plurality of coatings comprise respective compositions based on at least one composition, wherein the respective compositions comprise at least one of
at least one polymeric binder,
at least one carbon-sulfur composite, comprising
at least one carbon powder, and
at least one sulfur compound, and
at least one component other than the at least one polymeric binder and the at least one carbon-sulfur composite, and
(b) a composition comprising
about 1 to 17.5 average wt. % of at least one polymeric binder; and
about 50 to 99 average wt. % of at least one carbon-sulfur composite, the at least one carbon-sulfur composite comprising
at least one carbon powder characterized by having a surface area of about 50 to 4,000 square meters per gram and a pore volume of about 0.5 to 6 cubic centimeters per gram,
wherein the at least one carbon powder comprises carbon having a macromolecular structure ordered in at least two dimensions and characterized by having two-dimensional carbon sheets which are stacked into carbon layers, and
about 5 to 95 average wt. % of at least one sulfur compound in the at least one carbon-sulfur composite.

14. The method of claim 13, wherein the cell is associated with at least one of a portable battery, a power source for an electrified vehicle, a power source for an ignition system of a vehicle and a power source for a mobile device.

15. A carbon-sulfur composite that comprises
carbon powder characterized by having a surface area of about 50 to 4,000 square meters per gram and a pore volume of about 0.5 to 6 cubic centimeters per gram,
wherein the carbon powder comprises carbon having a macromolecular structure ordered in at least two dimensions and characterized by having two-dimensional carbon sheets which are stacked into carbon layers, and
about 5 to 95 wt. % sulfur compound in the carbon-sulfur composite.
